(19) United States
(12) Patent Application Publication
(10) Pub. No.: US 2024/0265654 A1
(43) Pub. Date: Aug. 8, 2024

(54) MULTIPOINT TOUCH ALIGNMENT FOR A REAL WORLD OBJECT IN EXTENDED REALITY

(71) Applicant: Taqtile, Inc., Seattle, WA (US)

(72) Inventors: John TOMIZUKA, Seattle, WA (US); Dirck T. SCHOU, JR., Bainbridge Island, WA (US)

(21) Appl. No.: 18/106,284

(22) Filed: Feb. 6, 2023

(51) Int. Cl. G06T 19/20; G06T 7/32; G06T 7/33; G06T 19/00

(52) U.S. Cl. CPC G06T 19/20; G06T 7/32; G06T 7/344; G06T 19/006; G06T 2200/24; G06T 2219/2004

(57) ABSTRACT

Alignment of an object or scene in an extended reality (XR) environment can be achieved using three points indicated by a user in the real world portion of the XR environment. To align a real world object with a corresponding model of the object, the user may employ a viewing device through which at least a portion of the object and/or scene can be viewed, with the ability to overlay virtual content on the real world perceived by the user. The user may indicate multiple points (for example, three points) on an object, or asset, of interest, the multiple points defining a real world coordinate space; and the multiple points may be correlated to corresponding points in the model to align the object as perceived by the user with the model, thereby enabling virtual content to be overlayed accurately on the real world object in the user's frame of reference.

### BACKGROUND

Presently, consumers may experience several different modes of virtual experiences via appropriately enabled user devices. In one example, a user experience may derive from computer-generated content executed via a virtual reality (VR) enabled device, which can provide a fully computer-generated visual experience that envelops the user. In another example, the user experience may derive from virtual content that overlays real-world content via an augmented reality (AR) device. In other words, the user experience may be comprised of a real-world experience that is augmented to include at least some computer-generated content. In yet another example, a user experience may derive from a combination of VR and AR, generated denoted as mixed reality (MR). While the term MR is intended to be more inclusive, it still excludes pure VR experiences. To cover all modes, the term XR (i.e., VR, AR, MR, etc.) may be used.

A virtual model of a physical object may be overlaid on the physical object in the user's view in the XR environment. To be useful, the overlaying model should be aligned with the physical object at least in position, and better in position, size, and/or orientation.

### SUMMARY

XR-enabled user devices can be deployed for a variety of purposes, including informational, educational, training, maintenance, construction, and gaming purposes, to name several. Virtual content overlaid on physical, or real world, content in an XR experience creates a desire for accuracy when the virtual content should be aligned with the real world content. One way to improve the experience in the case of a real world object (asset) is to align points on the real world asset with points on a stored model, often an image, of the real world asset. Overlaying virtual content that is associated with the real world asset may be more accurate, and create an improved XR experience, if the alignment is accurate.

In a two-dimensional XR world, or considering a two-dimensional real world asset, two points of the real world asset, if aligned with a model of that asset, may be sufficient for alignment if the two points find a suitable correspondence. Even in a three-dimensional XR world with a three-dimensional real world asset, two points may be used for alignment, but chances are that failing to consider one coordinate of the three-dimensional coordinate space of the XR world, and the corresponding coordinate of the three-dimensional real world asset, will result in a deficient alignment. Consider identifying two points in the X-Y plane but failing to include a third point in the X-Y, X-Z, and Y-X planes, or a rotational component in the three-dimensional space. Orientation of the real world asset with respect to the model may render the model an inexact proxy for the real world asset, and thus an attempt to overlay virtual content may result in the virtual content being misplaced. Examples described herein consider three or more points of alignment to improve the accuracy of alignment and consequent overly of virtual content on the real world asset.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 is a diagram of an example operating environment for implementing multipoint alignment of a real world asset in an XR environment with a stored representation of the asset.

FIG. 2 illustrates an example of a user device that implements multipoint alignment in an XR environment.

FIG. 3 illustrates an example of a computing device configured to support implementation by a user device of multipoint alignment of a real world asset in an XR environment with a stored representation of the asset.

FIG. 4 illustrates an example of setting a first alignment point in an implementation of multipoint alignment in an extended reality environment.

FIG. 5 illustrates an example of setting a second alignment point in an implementation of multipoint alignment in an extended reality environment.

FIG. 6 illustrates an example of setting a third alignment point in an implementation of multipoint alignment in an extended reality environment.

FIG. 7 is a flow diagram of an example process for a user device to implement multipoint alignment in an extended reality environment.

FIG. 8 is a flow diagram of the example process for a computing device to cooperate with a user device to implement multipoint alignment in an extended reality environment.

### DETAILED DESCRIPTION

This disclosure is directed to techniques to align a physical, real world object, or “asset”, as perceived by a user with a stored image of the asset, enhancing the accuracy of controlling the presentation of virtual objects with respect to the real world perception in an extended reality (XR) environment.

For the sake of clarity in this description, a pseudo-acronym “XR” can represent a plurality of different modes through which users may experience virtual reality. For example, XR modes may include or refer to one or more of a virtual reality (VR) mode, an augmented reality (AR) mode, or a mixed reality (MR) mode. In addition, “real world” and “physical world” may be used interchangeably herein, unless context dictates otherwise.

In some aspects, in an XR environment, real world objects may be said to reside in a real world coordinate system or space, and virtual objects may appear or be superimposed on the real world, often without reference to a coordinate space. However, to a user acting within the XR environment, it can be important for some virtual objects to be located in the user's view frame with a consistent spatial relationship to the real world frame of reference. Looking at the physical environment through an XR viewing device such as a headset, or goggles for example, a user's frame of reference is that of the viewing device's coordinate space.

In order to accurately present virtual objects in the real world space and with respect to objects within it, it may be helpful to insert the virtual objects into the real world coordinate space. One way to accomplish this may include, foundationally, aligning a real world object as perceived by the user through the viewing device (directly or as a camera image) with a stored version, or model, of the object. Once aligned, actions taken with respect to the stored version can be replicated to the real world object with accuracy commensurate with the accuracy of alignment. For example, a virtual bright circle may be rendered over an item of interest in the stored object and projected onto the corresponding item in the real world object to draw the user's attention, but the user may perceive the virtual circle at the intended location only to the extent that the real world object is aligned with the stored object.

In some examples, alignment may be achieved by correlating points on the real world object with corresponding points on the stored image. These points, when correlated, can be used to correlate all corresponding points in the object and image, with accuracy limited as noted. One way to accomplish this is with a transformation matrix to map the coordinates of these points. Various algorithms can be employed to determine the transformation matrix. In some embodiments, more than one transformation matrix may be applied.

In a two-dimensional space, two points may define a coordinate space. In a three-dimensional space, three points are more useful. Alignment can be performed in a three-dimensional space using two points, but with the third dimension un-anchored, accuracy of operations performed virtually, or associations of virtual content with physical content, can only be reliably translated to the real world, if at all, in two dimensions.

Therefore, in one or more aspects, alignment of an object or scene can be achieved using three points indicated by the user in the real world. For example, to align a real world object with its stored “twin,” the user may don or otherwise employ a viewing device through which at least a portion of the object and/or scene can be viewed, with the ability to overlay virtual content on the real world perceived by the user, creating an XR environment. In some embodiments, the user may indicate multiple points (for example, three points) on an object, or asset, of interest, the multiple points defining a real world coordinate space; and the multiple points may be correlated to corresponding points in the stored image of the object to align the object as perceived by the user with the stored object, thereby enabling virtual content to be overlayed accurately on the real world object in the user's frame of reference.

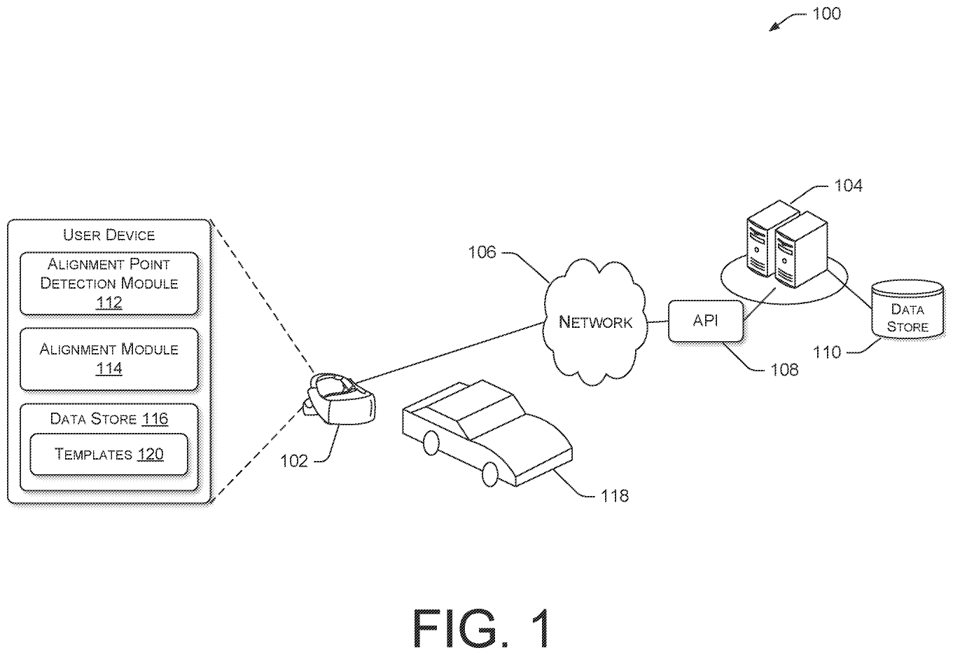

FIG. 1 is a diagram of an example operating environment 100 for implementing multipoint alignment of a real world asset in an XR environment with a stored representation of the asset. The diagram is meant to merely represent a high-level of elements and features to describe an operating environment. Further details are shown and described, below, with respect to the accompanying figures.

The illustrated operating environment 100 may include a user device 102 that communicates with a computing device 104. Communication may be over a network 106 as illustrated, but communication need not require a network and may be, for instance, peer-to-peer. An application programming interface 108 facilitates interactions between the user device 102 and the computing device 104, including storage and retrieval of image data and other data related to the multipoint alignment techniques described herein. Some of the data may be obtained from a data store 110 or other source.

The user device 102 can comprise various VR, AR, and MR viewing devices and/or components, such as a headset, goggles, or other head-mounted device (HMD). The user device 102 may also include general-purpose computing components that are capable of receiving input, processing the input, and generating output data to facilitate an XR platform.

The user device 102 may be configured with an alignment point detection module 112, an alignment module 114, and a data store 116. The alignment point detection module 112 may detect alignment points indicated by the user on a real world asset 118 and, in some embodiments, output the locations of the alignment points for correlation with corresponding points of stored models and/or images. The alignment module 114 may receive the locations of the alignment points output by the alignment point detection module 112, and correlate the detected alignment points with corresponding points in a stored representation of the real world asset 118. Confirmation of correlation establishes alignment. The data store 116 may store templates 120 that hold various data associated with respective real world assets 118. In the example depicted in FIG. 1, the subject or “asset” 118 of alignment is a vehicle, although assets are not limited to vehicles and may indeed be any of a variety of physical, real world objects in the XR environment. Moreover, individual alignment points can be indicated on more than one object to lock a stored representation of a scene, or of multiple objects, etc.

The computing device 104 may include one or more servers that support the multipoint alignment detection performed by the user device 102. In some examples, the computing device 104 may provide data of the real world asset 118 for alignment determining or confirmation as described elsewhere herein. The computing device 104 also may provide a guidance for the user of the user device 102 to follow in setting the alignment points.

The network 106 may include public networks such as the Internet, private networks such as institutional and/or personal intranet, or some combination of private and public networks. For example, the network 108 can implement 2G, 3G, 4G, 5G, LTE, LTE advanced, high-speed data packet access (HSDPA), evolved high-speed packet access (HSPA+), UMTS, code-division multiple access (CDMA), GSM, a local area network (LAN), a wide area network (WAN), and/or a collection of networks (e.g., the Internet), as well as a wireless IP protocol (e.g., Wi-Fi, IEEE 802.11).

The data store 110 may be configured as a relational database, an object-oriented database, a NoSQL database, and/or a columnar database, or any configuration to support scalable persistence. The data store 110 may store reference information respecting correlations between points on the real world object and previously stored images and other reference information, XR templates that correspond to a real world object or predefine an XR environment related to a geographic region (i.e., the real world environment or reference positions on the real world asset 118), and/or other data useful to carrying out its functions as described herein. The data store 110 may form part of the user device 102, be accessible locally or remotely, and/or stored in whole or in part in the cloud and uploaded to the user device 102 as needed.

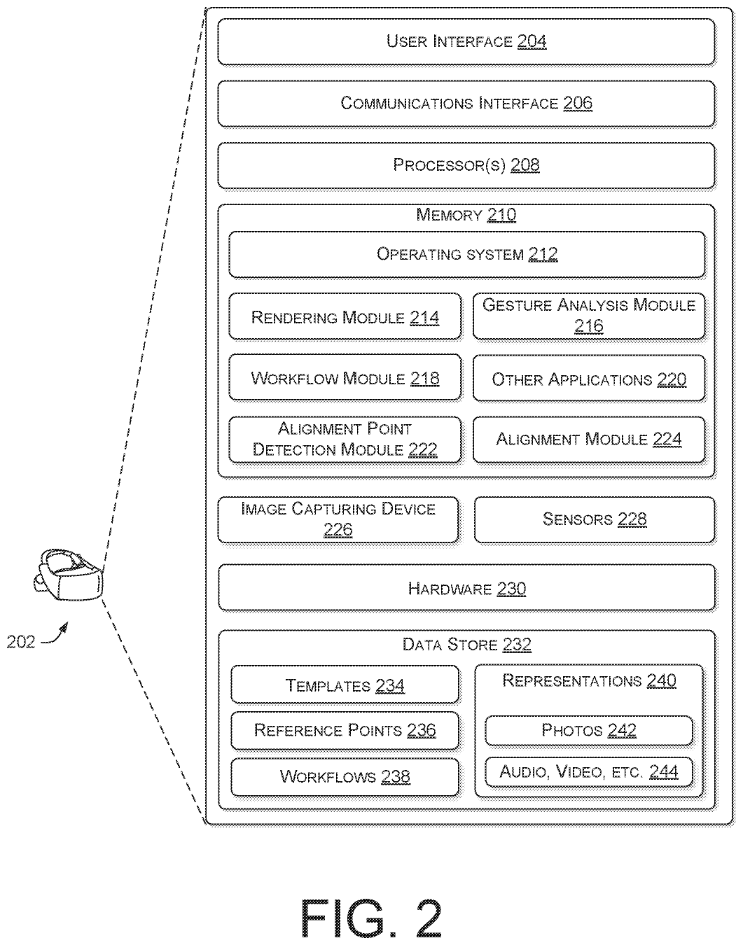

FIG. 2 illustrates an example of a user device 202 that implements multipoint alignment in an XR environment. The user device 202 can operate with more or fewer of the components shown. In some examples, the user device 202 may correspond to the user device 102.

The user device 202 may include a user interface 204, a communications interface 206, one or more processors 208, and memory 210. The memory 210 may store one or more of an operating system 212, a rendering module 214, a gesture analysis module 216, a workflow module 218, and one or more other applications 220 to execute various functions of the user device 202 and/or other operations under the control of the user and the like. The memory 210 may also store an alignment point detection module 222 and an alignment module 224. Further, in at least some embodiments, the user device 202 may include an image capturing device 226 (e.g., a camera), sensors 228, miscellaneous hardware 230, and a data store 232, which may store one or more of templates 234, reference points 236, workflows 238, and representations 240 related to real world assets 118.

The user interface 204 may enable a user of the user device 202 to provide input and receive output from the computing device 104, including for example providing input to execute functions performed by the user device 202, manipulate virtual objects in the XR environment, provide virtual or real annotations, and/or the like. The user interface 204 may include a data output device (e.g., visual display, audio speakers), and one or more data input devices. The data input devices may include, but are not limited to, combinations of one or more of touch screens, physical buttons, cameras, fingerprint readers, keypads, keyboards, mouse devices, microphones, speech recognition packages, and any other suitable devices or other electronic/software selection methods.

The communications interface 206 may include wireless and/or wired communication components that enable the user device 202 to transmit data to and receive data from other devices.

The processor(s) 208 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. In at least one example, the processor(s) 208 may comprise one or more central processing units (CPU), graphics processing units (GPU), both CPU and GPU, or any other sort of processing unit(s). The processor(s) 208 may also be responsible for executing all computer applications stored in the memory 210, which can be associated with common types of volatile (RAM) and/or nonvolatile (ROM) memory.

The memory 210 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The memory 210 may store several software components including the operating system, modules, and applications mentioned above. In general, a software component may include a set of computer executable instructions, which may be stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

The operating system 212 may include components that enable the user device 202 to receive and transmit data via various interfaces (e.g., user controls, communications interface, and/or memory input/output devices), as well as process data using the processor(s) 208 to generate output. The operating system 212 may include a presentation component that presents the output (e.g., projects images, displays data on an electronic display, stores data in memory, transmits data to another electronic device, etc.). Additionally, the operating system 212 may include other components that perform various additional functions generally associated with an operating system.

The rendering module 214 may generate and present information to the user, for example visible information viewable with the user device 202 and/or audio information via speakers on the user device 202. In some embodiments, the rendering module 214 may have one or more components for providing, on a display of the user device 202 or projected before the user's eyes, virtual content in an XR environment generated from data stored in the data store or received from the computing device 202 or other source. The virtual content may be associated with physical objects, virtual objects, or environmental data captured within the XR environment. For instance, the rendering module 214 may provide generated content using data from one or more of the sensors 228. In various embodiments, the rendering module 214 may generate certain content in response to receiving user input (e.g., gestures, voice commands, etc.). In addition to visually presenting virtual content, the rendering module 214 may also present content generated from the data visually, audibly, or in a sequence of haptic vibrations or an odor that is presented based on the fulfillment of appearance criteria.

The gesture analysis module 216 may capture and quantify gesture performed by a user via the XR-enabled user device 202. In some examples, the gesture analysis module 216 may compare a captured gesture against stored gestures or targets of gestures within an XR template to determine whether the gesture is an indicator for revealing virtual content, forgoing a presentation of virtual content, or indicating an alignment point. Moreover, the gesture analysis module 216 may also monitor the user's interaction within an XR environment. In some aspects, the gesture analysis module 216 may implement machine learning algorithms to analyze the user's actions and determine whether those actions are consistent with instructions annotated or recorded within corresponding virtual content.

The workflow module 218 may be implemented to construct, generate, and/or retrieve workflows 238. An example of a workflow 238 is a sequence of instructions for the user to follow when indicating alignment points. In some embodiments, a workflow 238 may be retrieved from an external source, such as the computing device 104. Workflows 238 may be pushed from an external source or downloaded on demand, for example by a user at time of use. Additionally, or alternatively, workflows 238 may be stored in the data store 232 for local retrieval. In some embodiments, the instructions may be received in display sequence or en masse, for example, for storage in the data store 232. Alternatively, or in addition, the instructions may be streamed for the user to follow in sequence as received. In such instances, the instructions may be buffered or received and displayed in response to a request by the user, for example one at a time as each direction is previewed, fulfilled, and/or reviewed.

The other applications 220 can be launched to enable the user device 202 to perform various operations consistent with a device that operates in an XR environment from the perspective of a user interacting with the XR environment.

The alignment point detection module 222 may, in response to user action, implement a registration of alignment points on the real world asset 118 to be matched to a stored representation or model. In some embodiments, the alignment point detection module 222 may input alignment points indicated by the user and received by the user device 202, points indicated within reference positions previously established for the asset. For example, the input may be a point of the real world asset, indicated by the user, sensed by one of the sensors 228, and/or analyzed by the gesture analysis module 216 in accordance with a workflow 238. In some embodiments, the alignment point detection module 222 may output, or cause to be output, via the rendering module 214 a virtual marker, highlight, or other representation to the user that an indicated point has been registered as an alignment point.

The alignment module 224 may obtain the alignment points input to the alignment point detection module 222 and align them with a stored representation of the real world asset 118. For example, the alignment module 224 may receive image data of the real world asset 118 and of the user's finger or other implement that indicates the alignment points. In some embodiments, the representation may be a photo, and the alignment module 224 may locate the indicated alignment points on the real world asset 118 from the image data. Using a triangulation algorithm and photo-matching, the alignment module 224 may correlate each of the alignment points with corresponding points of an image of the real world asset 118, or portion thereof, stored in the data store 232. By correlating at least three points on each, for example, the real world asset and stored representation may be locked in three dimensions with improved accuracy, whereby in the XR experience, virtual objects may be overlaid on the real world asset 118, remote actions with respect to the stored representation can be replicated with respect to the real world asset, and/or other interactions can be achieved between the real world and XR environment.

The image capturing device 226 may be one or more cameras or image sensors, capable of sensing images and reproducing the images as still photos or video, for example, and convert the same into image data. In some embodiments, the image capturing device 226 may sense and/or photograph a region of interest on the real world asset 118, an alignment point indicator (such as the user's finger), or both, as well as other features in the real world environment. For example, the image capturing device 226 a user may hover a finger or implement over an alignment point for a predetermined time, such as three seconds or other threshold as a rule enforced by the alignment point detection module 222, upon which the indicated point may be registered as an alignment point. In other examples, the user may unilaterally decide the registration by the indication (i.e., with or without reference to a specific threshold), take a photo of the alignment point, or perform the indication by another method such as by speaking.

The sensors 228 may include one or more devices that variously gather telemetry, media, and/or other data. Without limitation, the sensors 228 can comprise an image sensor, a temperature sensor, a proximity sensor, an accelerometer, an Infrared (IR) sensor, a pressure sensor, a light sensor, an ultrasonic sensor, a smoke, gas, an alcohol sensor, a Global Positioning System (GPS) sensor, a microphone, an olfactory sensor, a moisture sensor, and/or any type of sensors depending upon embodiments.

The hardware 230 may include additional user interface, data communication, or data storage hardware. For example, the additional user interface hardware may include a data output device and one or more data input devices in addition to those described above.

The data store 232 may be configured as a relational database, an object-oriented database, a NoSQL database, and/or a columnar database, or any configuration to support scalable persistence. The data store 232 may store one or more of templates 234, reference points 236, workflows 238, and representations 240 that correspond to a physical object or predefine an XR environment related to a geographic region (i.e., a physical environment), and/or so forth. The data store 232 can comprise a data management layer that includes software utilities for facilitating the acquisition, processing, storing, reporting, and analysis of data from multiple data sources.

The templates 234 may describe real world assets 118. For example, a template may relate to a real world asset 118 with which a user of the user device 202 may interact in both physical and virtual senses in the XR environment, including accessing physical and virtual content related specifically to the asset or components thereof. In the example of a vehicle, a template may include physical representations 240 (including, e.g., photos 242 and/or audio, video, or textual descriptions 244) of the vehicle and components of the vehicle, and virtual content such as markers, menus, or task-related content relating to maintenance, inspection, testing, and/or other workflows, directions, and/or instructions, for example. Thus, in some embodiments, the virtual content may guide a user accessing a template 234 through various processes with respect to the vehicle, e.g., through interaction with a virtual presentation of a sequence of directions and other virtual content.

The templates 234 can be stored as a table of data records for real world assets with fields pointing to other tables that may contain other information, for example data or metadata about the asset, photos or video of the asset, sounds or other sensory data related to the asset, reference points on the asset, or other information. Some or all of this information maybe be contained, alternatively or in addition, in tables or files with the template. The data store 232 may include data that may be stored in a cloud database, the computing device 104, or other storage and uploaded to the data store 232 for use by the user device 202. For example, in some embodiments, templates that correspond to a physical object or that predefine an XR environment related to a geographic region (i.e., a physical environment), and/or other data in the data store 232 that are created or modified by the user device 202 may be stored in a remote storage during and then uploaded to the data store 232. Some or all of the data may be stored in the user device 202, too.

The reference points 236 may be points in the data referenced to locations on the stored representation 240 of an asset, corresponding to alignment points indicated according to the instructions. In various examples, the alignment point detection module 222 may facilitate the association of a virtual marker with each indicated alignment point for the benefit of the user. As described elsewhere herein, the virtual marker can be a visual marker such as a pin, dot, or some form of highlighting such as a change in color at the indicated location; however, other sensory modalities are contemplated, such as auditory, haptic, olfactory, or any combination thereof. For example, rather than configuring the XR template to visually present a pin that overlays a real-world object, the marker may comprise of an audible message, a sequence of haptic vibrations, or an odor that is presented based on fulfillment of appearance criteria.

In one example, three reference points 236 may be determined and stored in advance to represent three points on a stored image of the real world asset 118, the three reference points corresponding to three alignment points indicated by the user on the asset as described herein. The reference points 236 for one template 234 may be stored with an association to one another, e.g., in a relational database.

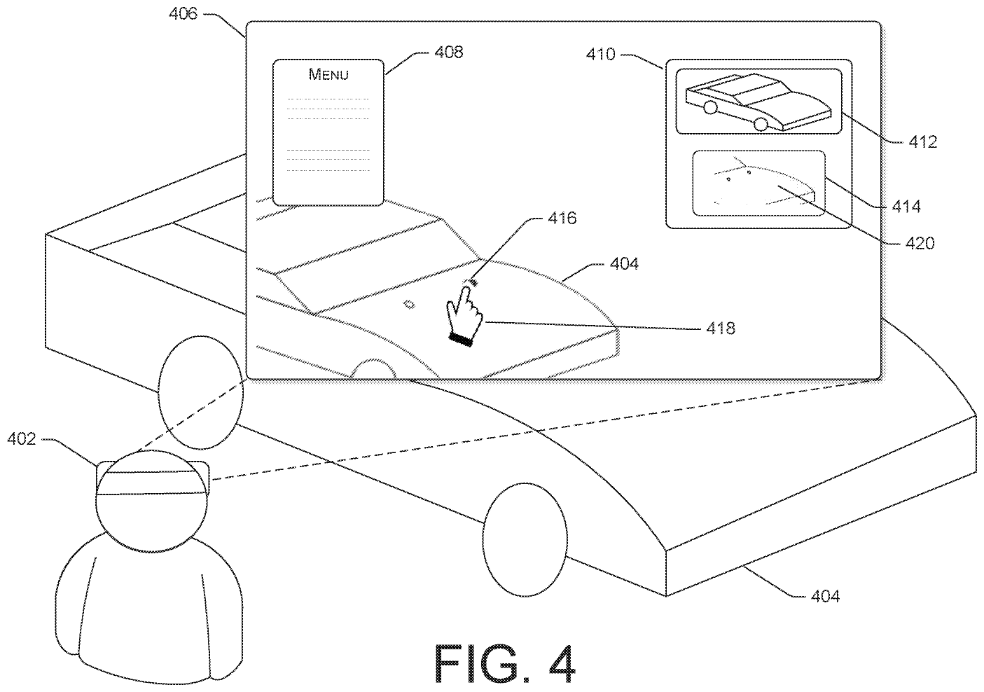

The workflows 238 may be added to a template or templates 234 prepared for a particular real world asset 118. One example of a workflow 238 may include the instructions for setting the alignment points as described herein. In this and other examples, the workflow 238 may implement guidance to the user to carry out tasks other than or in addition to setting alignment points. In some embodiments, the guidance may employ one or more instructions, including in some examples a set of step-by-step instructions, such as a wizard, to guide the user through the process of setting alignment point or other processes. Virtual reality technology may be employed at least in part as the guidance. Examples are described elsewhere herein, including with reference to FIGS. 4-6.

The representations 240 may be stored content relating to various real world assets 118, scenery, background, environment, or portions of any or all of these. In some embodiments, the representations 240 may include photos 242 of the real world assets 118, including photos 242 of the entire asset (head-on, panorama, 360° view, etc.) or portions thereof. Some of the photos 242 may be used as reference positions in the indication of alignment points as described elsewhere herein. Audio, video, text, and other forms of content 244 relating to the real world of the XR experience may also be stored as representations 240.

The photos 242 may be taken in advance of an actual alignment setting and stored in the data store 232 as representations 240. As noted elsewhere, the photos 242 may be taken and/or stored externally, and transmitted to the user device 202 as determined by an external user (such as an instructor or monitor), pushed according to a schedule, or retrieved on demand from another external data source. In some examples, the photos 242 may include photos of a real world asset 118, including photos of portions of the asset that correspond or include alignment points to be indicated by the user of the user device 202 as part of the alignment process described herein.

Other representations stored in the data store 232 may include audio, video, text, etc. 244. Some of these other representations, as in the case of the photos 242, may be received from or by control of an external user (such as an instructor or monitor), pushed according to a schedule, or retrieved on demand from another external data source. In some embodiments, audio may be recorded and/or played back to the user by hardware on the user device 202. The audio may include audio instructions in addition to or instead of photos 242. For example, the audio instructions may accompany and describe elements of or related to the real world asset 118 shown in the photos 242 viewable by the user of the user device 202. Similarly, video and/or text may accompany and describe elements of or related to the real world asset 118 that might be useful to the user in performing a task with respect to the asset.

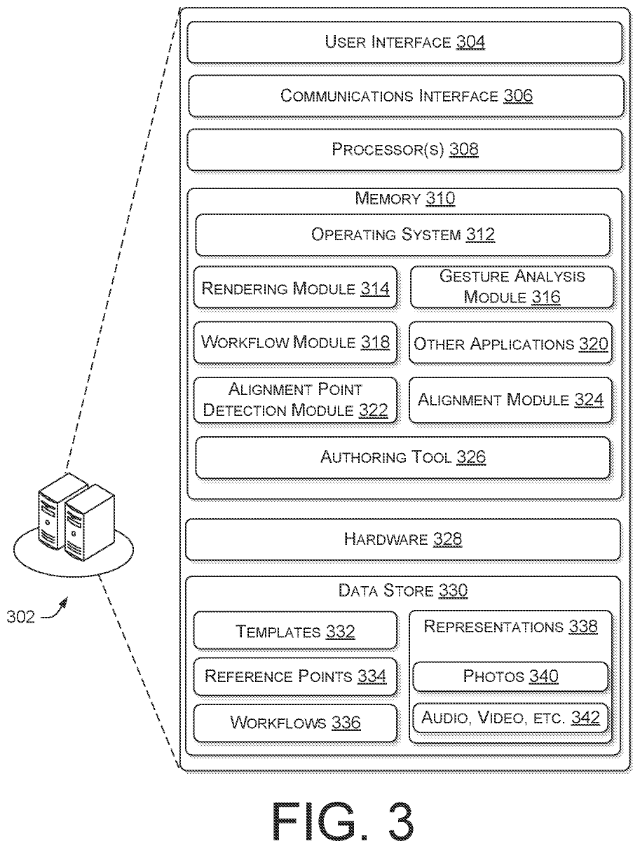

FIG. 3 illustrates an example of a computing device 302 configured to support implementation by a user device of multipoint alignment of a real world asset in an XR environment with a stored representation of the asset. The computing device 302 can operate with more or fewer of the components shown. In some examples, the user device may be the user device 202.

The computing device 302 may include a user interface 304, a communications interface 306, one or more processors 308, and memory 310. The memory 310 may store one or more of an operating system 312, a rendering module 314, a gesture analysis module 316, a workflow module 318, and one or more other applications 320 to execute various functions of the computing device 302 and/or other operations under the control of the user and the like. The memory 310 may also store an alignment point detection module 322, an alignment module 324, and an authoring tool 326. Further, in at least some embodiments, the computing device 302 may include miscellaneous hardware 328 and a data store 330, which may store one or more of templates 332, reference points 334, workflows 336, and representations 338 related to real world assets 118.

The user interface 304 may enable a user of the computing device 302 to provide input and receive output from the computing device 302, including for example providing one or more input to send instructions to the user device 202 to present guidance about performing a task or templates or other information related to performing a task. The user interface 304 also may include a data output device (e.g., visual display, audio speakers). The data input devices may include, but are not limited to, combinations of one or more of touch screens, physical buttons, cameras, fingerprint readers, keypads, keyboards, mouse devices, microphones, speech recognition packages, and any other suitable devices or other electronic/software selection methods.

The communications interface 306 may include wireless and/or wired communication components that enable the computing device 302 to transmit data to and receive data from other devices.

The processor(s) 308 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. In at least one example, the processor(s) 308 may comprise one or more central processing units (CPU), graphics processing units (GPU), both CPU and GPU, or any other sort of processing unit(s). The processor(s) 308 may also be responsible for executing all computer applications stored in the memory 310, which can be associated with common types of volatile (RAM) and/or nonvolatile (ROM) memory.

The memory 310 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The memory 310 may store several software components including the operating system, modules, and applications mentioned above. In general, a software component may include a set of computer executable instructions, which may be stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

The operating system 312 may include components that enable the computing device 302 to receive and transmit data via various interfaces (e.g., user controls, communication interface, and/or memory input/output devices), as well as process data using the processors 308 to generate output. The operating system 312 may include a presentation component that presents the output (e.g., displays the data on an electronic display, stores the data in memory, transmits the data to another electronic device, etc.). Additionally, the operating system 312 may include other components that perform various additional functions generally associated with an operating system.

The rendering module 314 may generate and/or send information to the user device 202, for example virtual object information viewable with the user device 202 and/or audio information via speakers on the user device 202. In some embodiments, the rendering module 314 may have one or more components for providing, formatted for display by the user device 202 or projected before the user's eyes, virtual content in an XR environment. The virtual content may be associated with physical objects, virtual objects, or environmental data within the XR environment. In various embodiments, the rendering module 314 may generate certain content in response to receiving user input (e.g., gestures, voice commands, etc.). In addition to visually presenting virtual content, the rendering module 314 may also present content generated from the data visually, audibly, or in a sequence of haptic vibrations or an odor that is presented based on the fulfillment of appearance criteria.

The gesture analysis module 316 may capture and quantify gestures performed by a user and sent to the computing device 302 from the XR-enabled user device 202. In some examples, the gesture analysis module 316 may compare a captured gesture against stored gestures or targets of gestures within an XR template to determine whether the gesture is an indicator for revealing virtual content, forgoing a presentation of virtual content, or indicating an alignment point. Moreover, the gesture analysis module 316 may also monitor the user's interaction within an XR environment. In some aspects, the gesture analysis module 316 may implement machine learning algorithms to analyze the user's actions and determine whether those actions are consistent with instructions annotated or recorded within corresponding virtual content.

The workflow module 318 may be implemented to construct, generate, and/or retrieve workflows 336 in a manner similar to the workflow module 218. In some embodiments, the computing device 302 may send a workflow 336 to the user device 202 for implementation via its workflow module 318. As described with respect to the workflow module 218, an example of a workflow 336 is a sequence of instructions for the user to follow when indicating alignment points.

The other applications 320 can be launched to enable the user device 302 to perform various operations consistent with a device that controls a device operating in an XR environment, including guiding interaction from the perspective of a user interacting with the XR environment.

The user device 202 may include the alignment point detection module 222 and the alignment module 324 as described above. In some embodiments, however, one or more of the functions of the alignment point detection module 222 and/or the alignment module 224 may be performed on the computing device 302, which may output results to the user device 202 for execution or inclusion to similar ends. In such embodiments, the computing device 302 may have an alignment point detection module 322 and an alignment module 324. Like the alignment point detection module 222, the alignment point detection module 322 may, in response to user action sensed by the gesture analysis module 216 and output to the computing device 302, implement a registration of alignment points on the real world asset 118 to be matched to a stored representation or model. In some embodiments, user gestures may be sensed by the user device 202 and transmitted to the computing device 302 for analysis by the gesture analysis module 316. The alignment point detection module 322 may input alignment points indicated by the user and received by the user device 302, points indicated within reference positions previously established for the asset. For example, the input may be a point of the real world asset 118, indicated by the user, sensed by one of the sensors 228, and sent to the computing device 302 in accordance with a workflow 338. In some embodiments, the alignment point detection module 222 may output, or cause to be output, via the rendering module 314 a virtual marker, highlight, or other representation to the user that an indicated point has been registered as an alignment point.

The alignment module 324 may obtain the alignment points input to the user device 202 and sent to the computing device 302, and align them with a stored representation of the real world asset 118. For example, the alignment module 324 may receive image data of the real world asset 118 and of the user's finger or other implement that indicates the alignment points. In some embodiments, the representation may be a photo, and the alignment module 324 may locate the indicated alignment points on the real world asset 118 from the image data. Using a triangulation algorithm and photo-matching, the alignment module 324 may correlate each of the alignment points with corresponding points of an image of the real world asset 118, or portion thereof, stored in the data store 320. By correlating at least three points on each, for example, the real world asset 118 and stored representation may be locked in three dimensions with improved accuracy, whereby in the XR experience, virtual objects may be overlaid on the real world asset 118, remote actions with respect to the stored representation can be replicated with respect to the real world asset, and/or other interactions can be achieved between the real world and XR environment.

The authoring tool 326 may permit a user of the computing device 302 to create workflows 336 that may relate, without limitation, to establishing alignment points, accuracy testing, rule setting, and the like. In particular, the authoring tool 326 may enable the user of the computing device 302 to create and modify workflows 336, including workflows 336 sent to the user device 202 via the workflow module 318. In some embodiments, one or more of the workflows 336 may be added to a template or templates prepared for a particular real world asset 118. One example of a workflow 336 may include the instructions for setting the alignment points as described herein. The authoring tool 326 may be configured to add, change, or remove markers, content, and behavior, for example in a template that may be made from scratch or an existing template, either of which may be stored locally at the data store 232 or at the data store 320.

The hardware 328 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The data store 330 may be configured as a relational database, an object-oriented database, a NoSQL database, and/or a columnar database, or any configuration to support scalable persistence. The data store 330 may store one or more of templates 332, reference points 324, workflows 336, and representations 338 that correspond to a physical object or predefine an XR environment related to a geographic region (i.e., a physical environment), and/or so forth. The data store 330 may include data that may be stored in a cloud database, or other storage and uploaded to the data store 330 for use by the user device 202. In some embodiments, templates that correspond to a physical object or that predefine an XR environment related to a geographic region (i.e., a physical environment), and/or other data in the data store 330 that are received, created, or modified by the computing device 302 may be stored in a remote storage during and then uploaded to the data store 330.

The templates 332 may be similar or identical to the templates 234 and describe real world assets 118. In some embodiments, the computing device 302 may store and send a template 332 to the user device 202, rather than the user device relying on a locally stored template. For example, a template 332 may be created and/or stored on the computing device 302 and sent to the user device 202 for implementation of the alignment point setting process and for reference to other information stored in the template 332 in a manner similar to the template 234. Thus, in some embodiments, the template 332 may guide a user of the user device 202 accessing the template through various processes with respect to the real world asset 118, e.g., through interaction with a virtual presentation of a sequence of directions and other virtual content, as described with respect to the template 234.

The templates 332 can be stored as a table of data records for real world assets 118 with fields pointing to other tables that may contain other information, for example data or metadata about the asset, photos or video of the asset, sounds or other sensory data related to the asset, reference points on the asset, or other information. Some or all of this information maybe be contained, alternatively or in addition, in tables or files with the template. The data store 330 may include data that may be stored in a cloud database, the computing device 302, or other storage and uploaded to the data store 330 for use by the computing device 302 and/or the user device 202. For example, in some embodiments, templates that correspond to a physical object or that predefine an XR environment related to a geographic region (i.e., a physical environment), and/or other data in the data store 330 that are created or modified by the user device 202 may be stored in a remote storage during and then uploaded to the data store 330. Some or all of the data may be stored in the user device 202, too.

The reference points 334 may be similar to the reference point 226 but stored in the data store 330. Thus, the reference points 334 may be points in the data referenced to locations on the stored representation 338 of an asset, corresponding to alignment points indicated according to the instructions. In various examples, the alignment point detection module 322 may facilitate the association of a virtual marker with each indicated alignment point for the benefit of the user. As described elsewhere herein, the virtual marker can be a visual marker such as a pin, dot, or some form of highlighting such as a change in color at the indicated location; however, other sensory modalities are contemplated, such as auditory, haptic, olfactory, or any combination thereof. For example, rather than configuring the XR template to visually present a pin that overlays a real-world object, the marker may comprise of an audible message, a sequence of haptic vibrations, or an odor that is presented based on fulfillment of appearance criteria.

In one example, three reference points 334 may be determined and stored in advance to represent three points on a stored image of the real world asset 118, the three reference points corresponding to three alignment points indicated by the user on the asset as described herein. The reference points 334 for one template 332 may be stored with an association to one another, e.g., in a relational database.

The workflows 336 may be similar to the workflows 238. The workflows 336 may be added to a template or templates 332 prepared for a particular real world asset 118. One example of a workflow 336 may include the instructions for setting the alignment points as described herein. In this and other examples, the workflow 336 may implement guidance to the user to carry out tasks other than or in addition to setting alignment points. In some embodiments, the guidance may employ one or more instructions, including in some examples a set of step-by-step instructions, such as a wizard, to guide the user through the process of setting alignment point or other processes. Virtual reality technology may be employed at least in part as the guidance. Examples are described elsewhere herein, including with reference to FIGS. 4-6.

The representations 338 may be stored content relating to various real world assets, scenery, background, environment, or portions of any or all of these. In some embodiments, the representations 338 may include images of the real world assets 118, including photos 340 of the entire asset (head-on, panorama, 360° view, etc.) or portions thereof. Some of the photos 340 may be used as reference positions in the indication of alignment points as described elsewhere herein. Audio, video, text, and other forms of content 342 relating to the real world of the XR experience may also be stored as representations 338.

The photos 340 may be taken in advance of an actual alignment setting and stored in the data store 330 as representations 338. As noted elsewhere, the photos 340 may be taken and/or stored externally, and transmitted to the computing device 302 as determined by an external user (such as an instructor or monitor), pushed according to a schedule, or retrieved on demand from another external data source. In some examples, the photos 340 may include photos of a real world asset 118, including photos of portions of the asset that correspond or include alignment points to be indicated by the user of the user device 202 as part of the alignment process described herein. The photos 340 may be sent to the user device 202 to be used in this processes or other processes that benefit from photos presented via the user device 202.

Other representations stored in the data store 330 which may include audio, video, text, etc. 342. Some of these other representations, as in the case of the photos 340, may be received from or by control of an external user (such as an instructor or monitor), pushed according to a schedule, or retrieved on demand from another external data source. Such other representations may be sent to the user device 202 to be used in this processes or other processes that benefit from photos presented via the user device 202. In some embodiments, audio may be recorded and/or streamed to the user. The audio may include audio instructions in addition to or instead of photos 340. For example, the audio instructions may accompany and describe elements of or related to the real world asset 118 shown in the photos 340 viewable by the user of the user device 202. Similarly, video and/or text may accompany and describe elements of or related to the real world asset 118 that might be useful to the user in performing a task with respect to the asset.

FIG. 4 illustrates an example of setting a first alignment point 416 in an implementation of multipoint alignment in an extended reality environment. In the illustrated example, a user of a user device 402 experiences a real world asset 118, here the vehicle 404, in an XR scenario 406 with virtual objects that include a menu 408, a workflow window 410 that includes a first box 412 depicting the vehicle 404 and a second box 414 depicting a set of instructions to guide the user according to the workflow 238, a first alignment point 416, and the user's hand 418 (which may be real or virtual, directed by the user or remotely). In this example, the user device 402 can be a headset having at least some of the features of the user device 202 illustrated in FIG. 2, and the XR scenario 406 corresponds to the field of view of the headset. In general, the user device 402 need not be a headset, but can be another viewing device such as goggles. In some embodiments, the user device 402 may lack viewing capabilities. Further, the multipoint alignment techniques described here can be implemented by indicating a system of multiple alignment points on any of a variety of single objects, which are not limited to a vehicle, and in some embodiments may be implemented by indicating a system of multiple alignment points on plural objects (e.g., by indicating one or more alignment points on each of plural objects, the indicated points comprising the system of alignment points).

In this example, a virtual model of the vehicle 404 is being aligned with the real world vehicle 404 using three alignment points. The use of three alignment points is sufficient for many alignments in three dimensions. More than three alignment points may be used. Two alignment points, while sufficient for some alignments, is not reliably accurate in three dimensions for many XR scenarios.

Illustratively, the process of setting alignment points may have the user of the user device 402 retrieving a template, such as one of the templates 234, from local storage such as the data store 232. In some embodiments, the user, or the user device 202 automatically upon recognition of the vehicle 404 as a subject of a task, may download the template 234. The template 234 may describe attributes of the vehicle 404 such as physical representations 240 (e.g., photos 242 and/or audio, video, or textual descriptions 244) of the vehicle and components of the vehicle, and virtual content such as markers, menus, or task-related content relating to maintenance, inspection, testing, and/or other workflows 238 and/or directions or instructions, for example. Thus, in some embodiments, the virtual content may guide a user accessing the template 234 through various processes or tasks of a workflow 238 with respect to the vehicle 404, e.g., through interaction with a virtual presentation of a sequence of instructions and other virtual content customized to the vehicle 404 for the purpose of carrying out the task. The workflow module 218 may present the workflow 238 to carry out the task in accordance with information derived from the template 234.

In some embodiments, the template 234 may present guidance in the form of a set of instructions guiding the user to multiple reference positions (three in this example) in the real world portion of the XR scenario 406. The instructions, which may be presented via the second box 414, may include one or more of the representations 240, including but not limited to the photos 242 and/or audio, video, text, etc. 244 retrieved from the data store 232. To that end, the instructions may be generated and presented for display in the second box 414 to the user via the rendering module 214. In this example, the menu 408 may display attributes of the vehicle as the subject of the guidance in response to retrieval of the template 234. In some examples, the user may select from the menu 408 the asset (here, the vehicle 404) as the subject of the guidance, responsive to which the workflow module 218 or other component of the user device 202 may retrieve the template 234. Accordingly, an image of the vehicle 404 as the real world asset 118 may be displayed in the first box 412 and instructions to the user displayed in the second box 414 by the rendering module 214 in accordance with the representations 240.

In this example, as part of a first instruction, a first reference position 420 of the vehicle 404 may be displayed in the second box 414. The first reference position 420 may be a photo of a first portion of the vehicle 404. In this embodiment, it is at this reference position 414 that the user will indicate the first alignment point 416. Text or other information may be displayed as well in the second box 414 as part of the first instruction and/or other instructions in the set. Displaying the vehicle 414 in the first box 412 can be used to confirm that the vehicle 404 before the user in the real world is indeed the asset that is the subject of the workflow 238. In some embodiments, however, the first box 412 need not display the vehicle 404 or may be omitted.

In the illustrated example, the user 402 may learn from the second box 414 that the first reference position 420 is in the vicinity of the left windshield washer nozzle (from the perspective of the driver) and thus, the user may comply with the first instruction by reaching forward and indicating (e.g., touching or hovering a pointed finger over the nozzle) the first alignment point 416 at the windshield washer nozzle. The user device 402 may receive input that includes the first alignment point 416 indicated within the first reference position 420 (for example, the rendering module 214 may insert a virtual marker or highlight in the user's view at the indicated first alignment point 416 and the image capturing device 226 may capture the image of the first reference position 420 with the indicated first alignment point 416 as rendered). In accordance with the workflow 238 executed by the workflow module 224, the captured image data with the indicated point as rendered may be stored in the photos 242 and/or output via the communications interface 206.

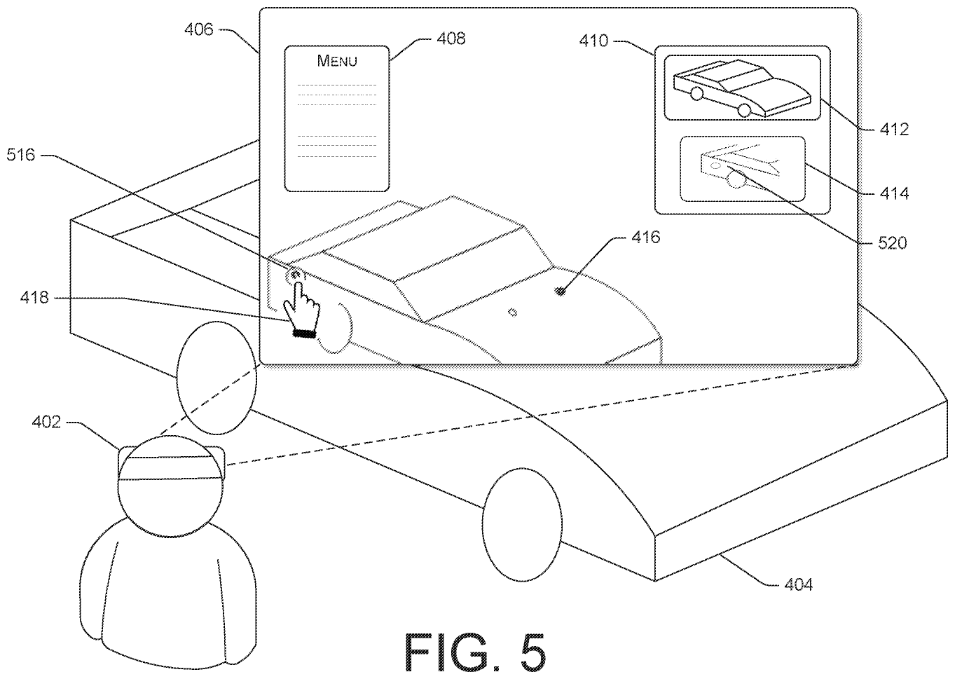

FIG. 5 illustrates an example of setting a second alignment point 516 in an implementation of multipoint alignment in an extended reality environment. In the illustrated example, the first alignment point 416 near the left windshield washer nozzle is shown as an indicated point. Similar to the description relating to FIG. 4, the user of the user device 402 may be presented with a second instruction, this time to a second reference position 520. The second reference position 520 may be a photo of a second portion of the vehicle 404. For example, a second instruction in the workflow 238 may cause the menu 408 and/or the workflow window 410 to be generated or updated, and presented to the user via the rendering module 214. In this example, the image of the vehicle 404 as the real world asset 118 may continue to be displayed in the first box 412 and the second instruction may be displayed in the second box 414. In this embodiment, it is at this reference position that the user will indicate the second alignment point 516. Text or other information may be displayed as well in the second box 414 as part of the second instruction.

In the illustrated example, the user 402 may learn from the second box 414 that the second reference position 520 is in the vicinity of the fuel cap and thus, the user may comply with the second instruction by reaching forward and indicating (e.g., touching or hovering a pointed finger over the fuel cap) the second alignment point 516 at the fuel cap. The user device 402 may receive input that includes the second alignment point 516 indicated within the second reference position 520 (for example, the rendering module 214 may insert a virtual marker or highlight in the user's view at the indicated second alignment point 516 and the image capturing device 226 may capture the image of the second reference position 520 with the indicated second alignment point 516 as rendered). In accordance with the workflow 238 executed by the workflow module 224, the captured image data with the second alignment point 516 as rendered, or both the first and second alignment points 416 and 516 as rendered, may be stored in the photos 242 and/or output via the communications interface 206.

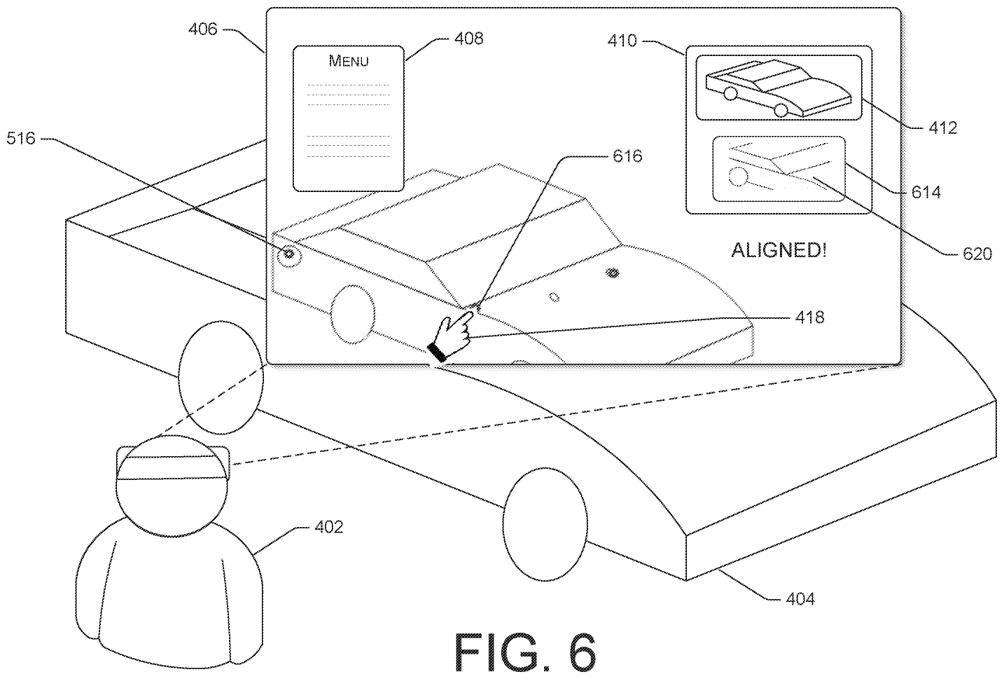

FIG. 6 illustrates an example of setting a third alignment point 616 in an implementation of multipoint alignment in an extended reality environment. In the illustrated example, the first alignment point 416 near the left windshield washer nozzle and the second alignment point 516 near the fuel cap are shown as indicated points. Similar to the descriptions relating to FIGS. 4 and 5, the user of the user device 402 may be presented with a third instruction, this time to a third reference position 620. The third reference position 620 may be a photo of a third portion of the vehicle 404. For example, a third instruction in the workflow 238 may cause the menu 408 and/or the workflow window 410 to be generated or updated, and presented to the user via the rendering module 214. In this example, the image of the vehicle 404 as the real world asset 118 may continue to be displayed in the first box 412 and the third instruction may be displayed in the second box 414. In this embodiment, it is at this reference position that the user will indicate the third alignment point 616. Text or other information may be displayed as well in the second box 414 as part of the third instruction.

In the illustrated example, the user 402 may learn from the second box 414 that the third reference position 620 is in the vicinity of the left upper portion of the hood (from the user's perspective) and thus, the user may comply with the third instruction by reaching forward and indicating (e.g., touching or hovering a pointed finger over the left upper portion of the hood) the third alignment point 616. The user device 402 may receive input that includes the third alignment point 616 indicated within the third reference position 620 (for example, the rendering module 214 may insert a virtual marker or highlight in the user's view at the indicated third alignment point 616 and the image capturing device 226 may capture the image of the third reference position 620 with the indicated third alignment point 616 as rendered). In accordance with the workflow 238 executed by the workflow module 224, the captured image data with the third alignment point as rendered, or all three of the alignment points 416, 516, and 616 as rendered, may be stored in the photos 242 and/or output via the communications interface 206.

Once the three alignment points are registered in this way, the alignment module 224 may execute an algorithm to compare the three alignment points with corresponding reference points 236 on the vehicle 404. For example, the alignment module 224 may photo-match the reference positions with the indicated alignment points to corresponding photos 242. Upon confirmation that the alignment points 416, 516, and 616 match the corresponding reference points within a predefined tolerance, the alignment module 224 may determine that alignment has been achieved. On the other hand, if there is insufficient correspondence (as determined, by the alignment module 224, that one of the alignment points does not match its corresponding reference point within the tolerance, or in some embodiments that two of the alignment points do not match their corresponding reference points within the tolerance), then the alignment module 224 may determine that alignment has not been achieved.

When, according to the workflow 238, the alignment task is completed with the indication of the third alignment point 616, the workflow module 224 may indicate that the alignment points 416, 516, and 616 are sufficient to register alignment of the real world vehicle 404 with the stored representation of the vehicle, for example with a graphic such as “ALIGNED” rendered by the rendering module 214. In some embodiments, in accordance with the workflow 238 executed by the workflow module 224, the captured image data, with the three alignment points as rendered, may be stored in the data store 232 or output via the communications interface 206 with the indication “aligned.” Alternatively, if alignment is not determined, a corresponding indication may be stored or output.

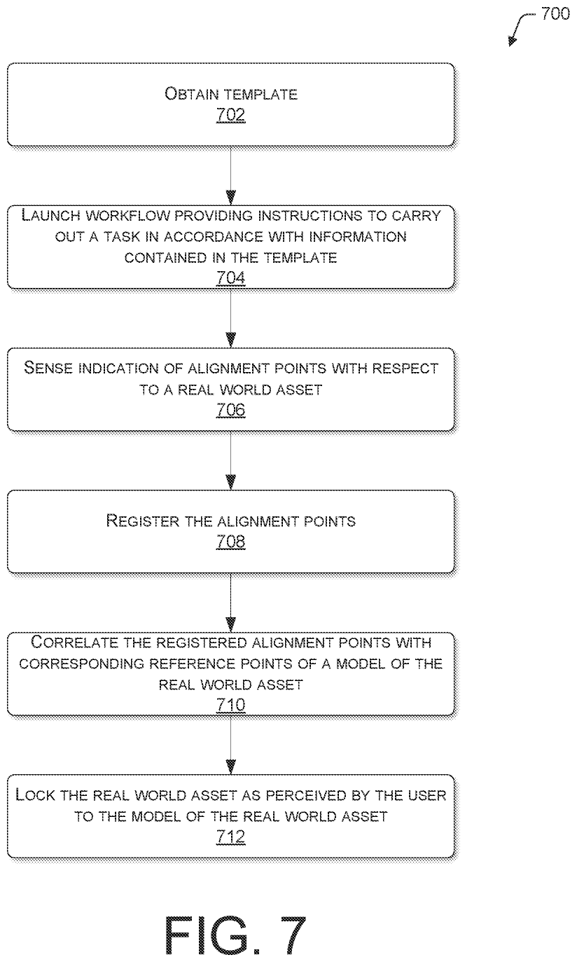

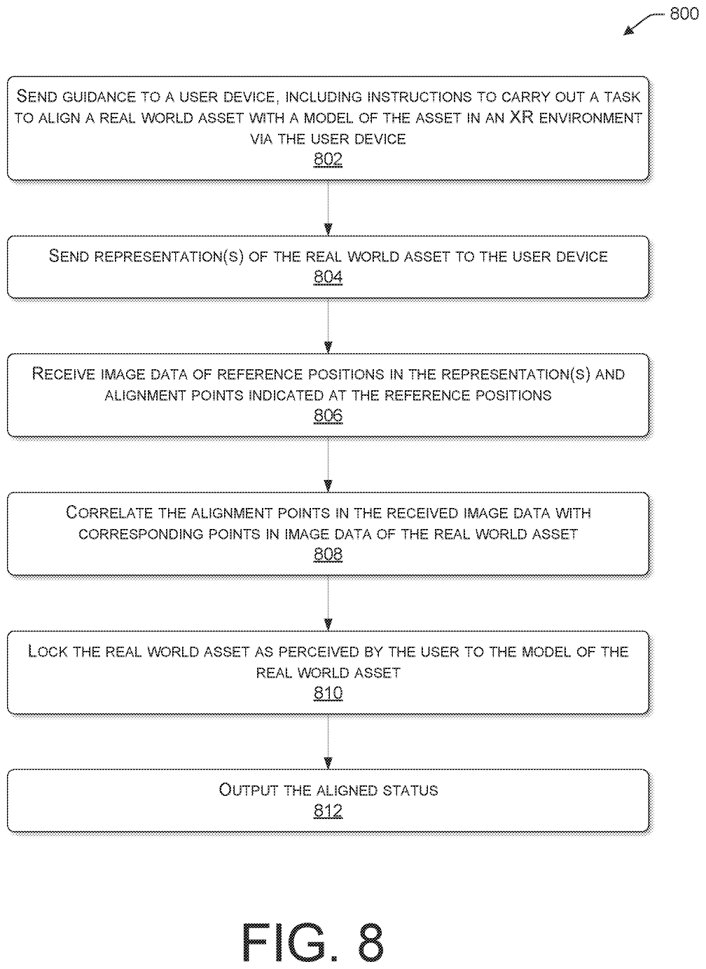

FIGS. 7 and 8 are flow diagrams of example processes 700 and 800 for implementing multipoint alignment in an extended reality environment. Each of the processes 700 and 800 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Additionally, in some embodiments, one or more of the operations included in the processes 700 and/or 800 may be performed or controlled by a device different from the user device 202 or computing device 302. For example, and without limitation, the user of the user device 202 may operate another device to perform and/or control one or more of the operations in addition to those performed and/or controlled by the user device 202 or computing device 302. For discussion purposes, the processes 700 and 800 are described with reference to FIGS. 1-6.

FIG. 7 is a flow diagram of an example process 700 for a user device to implement multipoint alignment in an extended reality environment. In the process 700, the user device, such as the user device 202, may be configured to receive instructions to reference positions where a user of the user device 202 may indicate alignment points to be matched to a model of a real world asset 118 and enable the model to be “locked” to the corresponding real world asset 118.

At block 702, the user device 202, under control of the processor(s) 208 executing one or more software modules described herein, may obtain a template 234 related to a real world asset 118. For example, the template may relate to a real world asset 118 with which the user of the user device 202 may interact in both physical and virtual senses in the XR environment, including accessing physical and virtual content related specifically to the real world asset 118 or components thereof. The template may include physical representations 240 (including, e.g., photos 242 and/or audio, video, or textual descriptions 244) of the asset and components of the asset, and virtual content such as markers, menus, or task-related content relating to maintenance, inspection, testing, and/or other workflows 238, directions, and/or instructions, for example. The virtual content may guide a user accessing the template 234 through various processes or tasks of a workflow 238 with respect to the real world asset 118, e.g., through interaction with a virtual presentation of a sequence of instructions and other virtual content customized to the real world asset 118 for the purpose of carrying out the task. A workflow module 218 may present the workflow 238 to carry out the task in accordance with information derived from the template 234. In some embodiments, the template 234 may present guidance in the form of a set of instructions guiding the user to perform a given task, such as the indication of alignment points.

At block 704, the workflow module 218, executed by the processor(s) 208, may launch the workflow 238 providing instructions to carry out a task in accordance with information contained in the template 234. In some embodiments, the workflow may be launched in response to an action by the user, such as a selection of the workflow, selection of the asset, or retrieval of the template, from the data store 232 on the user device or from an external data source. Similarly, the workflow 238 may be launched in response to the user device 202 receiving the template from an external source without request by the user. Launching the workflow 238 may cause a set of instructions to be presented to the user via, e.g., virtual content displayed via the user device 202. For example, a workflow window 410 may be presented with instructions displayed in a box such as the second box 414 in the workflow window 410. The instructions may include representations 240, such as photos 242, of the real world asset 118 as reference positions for the user to find respective alignment points.

At block 706, the alignment point detection module 222, executed by the processor(s) 208, may sense an indication of alignment points such as the alignment points 416, 516, and 616 with respect to the real world asset 118. In some embodiments, guided by the instructions, the user of the user device 202 may indicate alignment points on the real world asset 118, which indications may be sensed by the alignment point detection module 222. The indications may be made, for example by the user pointing at the alignment points or hovering a finger over the alignment points, one at a time, until the alignment point detection module 222 senses the alignment point.

At block 708, the alignment point detection module 222, executed by the processor(s) 208, may register the indicated points as alignment points to be correlated with a representation of the real world asset 118. In this regard, the registered points may not yet be determined to align with corresponding points. The alignment point detection module 222 may register the points one at a time in accordance with the alignment indication. That is, the alignment point detection module 222 may sense and register each alignment point in succession as the user indicates the point. Alternatively, the registration of all points may be done at the conclusion of the workflow 238. In some embodiments, the alignment point detection module 222 may output, or cause to be output, via the rendering module 214 a virtual marker, highlight, or other representation to the user that an indicated point has been registered as an alignment point.

At block 710, the alignment module 224, executed by the processor(s) 208, may correlate the registered alignment points with corresponding reference points 236 of a model of the real world asset 118. For example, the alignment module 224 may photo-match the reference positions with the indicated alignment points to corresponding photos 242. In some embodiments, the model may be an image stored in the representations 240, such as an image derived from one or more of the photos 242, with the reference points 236 being points in the image data. The alignment module 224 may determine whether the alignment points have sufficient corresponding reference points in the model to conclude that alignment has been achieved. The alignment module 224 may determine that there is alignment based on their being a minimum number of points being correlated. In some embodiments, at least three alignment points must correlate, within a tolerance, for a conclusion of alignment.

At block 712, the alignment module 224, executed by the processor(s) 208, may lock the real world asset 118 as perceived by the user of the user device 202 to the model of the real world asset 118. Locking the real world asset 118 with its stored model may be achieved as a result of finding correlation of the sufficient number of points. For example, in three dimensions, three correlated alignment points may define a three-dimensional object sufficiently for an accurate representation of that object to be proxy for the real world object for various purposes that may include, without limitation, examining, maintaining, testing, constructing, modifying, and/or deconstructing the real world object with a virtual representation of the real world object presented to the user via the user device 202.

FIG. 8 is a flow diagram of the example process 800 for a computing device (e.g., the computing device 302) to cooperate with a user device (e.g., the user device 202) to implement multipoint alignment in an extended reality environment. In the process 800, the computing device 302 may be configured to send guidance to the user device 202, including by which a user of the user device 202 may indicate alignment points to be matched to a stored model of a real world asset 118, enabling the model to be “locked” to the corresponding real world asset 118.

At block 802, the computing device 302, under control of the processor(s) 308 executing one or more software modules described herein, may send guidance to the user device 202, including instructions to carry out a task to align a real world asset 118 with a model of the asset in an XR environment via the user device 202. For example, the instructions may correspond to the instructions mentioned at block 704. In some examples, the guidance may be stored on the user device 202, and/or sent from another location other than the computing device 302.

At block 804, the computing device 302, under control of the processor(s) 308, may send representation(s) 338 of the real world asset 118 to the user device 202. The representation(s) 338 may include, for example, photos 340 or other representations 342 of the real world asset 118 to be the subject of the alignment described herein.

At block 806, the computing device 302, under control of the processor(s) 308, may receive image data of reference positions in the representation(s) 338 and alignment points indicated at the reference positions. For example, the reference positions may be the first, second, and third reference positions 420, 520, and 620, respectively, and the alignment points may be the first, second, and third alignment points 416, 516, and 616, respectively. In some embodiments, the image data may include a photo of the entire asset, including the reference positions, combined with the alignment points, and the alignment points may be marked or highlighted in some way.

At block 808, the alignment module 322, executed by the processor(s) 308, may correlate the alignment points in the received image data with corresponding points in image data of the real world asset 118. For example, the correlation may be similar to that carried out at block 710 by the alignment module 224, with respect to photo-matching the image data with image data of a model of the real world asset 118, with the reference points 334 being points in the image data.

At block 810, the alignment module 322, executed by the processor(s) 308, may lock the real world asset 118 as perceived by the user of the user device 202 to the model of the real world asset 118. Locking the real world asset 118 with its stored model may be achieved as a result of finding correlation of a sufficient number of points. For example, in three dimensions, three correlated alignment points may define a three-dimensional object sufficiently for an accurate representation of that object to be proxy for the real world object for various purposes that may include, without limitation, examining, maintaining, testing, constructing, modifying, and/or deconstructing the real world object with a virtual representation of the real world object presented to the user via the user device 202.

At block 312, the computing device 302, under control of the processor(s) 308, may output the aligned status to the user device 202 or to another recipient. For example, the computing device 302 may cause to be rendered on the user's view that the stored image and the real world image are “ALIGNED”.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable code that upon execution cause one or more processors to perform acts comprising:
obtaining a template related to a real world asset;
launching a workflow providing instructions to carry out a task with respect to the real world asset in an extended reality (XR) environment in accordance with information contained in the template;
sensing an indication of alignment points with respect to the real world asset;
registering the indicated points as alignment points to be correlated with a representation of the real world asset;
correlating the registered alignment points with corresponding reference points of a model of the real world asset; and
locking the real world asset as perceived by a user interacting with the real world asset in the XR environment, to the model of the real world asset according to the correlated alignment points.

2. The one or more non-transitory computer-readable media of claim 1, wherein the acts further comprise:
accessing physical and virtual content related to the real world asset from the template,
wherein the instructions guide the user with the virtual content to interact with physical aspects of the real world asset embodied in the physical content to carry out the task.

3. The one or more non-transitory computer-readable media of claim 2, wherein the physical content includes physical representations of the real world asset and the virtual content includes a sequence of the instructions customized to the physical representations of the real world asset.

4. The one or more non-transitory computer-readable media of claim 1, wherein the acts further comprise:
displaying the instructions to the user via a user device configured to present the XR environment to the user, the instructions being presented at least in part as virtual content in the user's view.

5. The one or more non-transitory computer-readable media of claim 1, wherein:
the instructions include virtual images, presented via the user device, of reference positions on the real world asset, each of the reference positions including a respective one of the alignment points; and
the instructions present the virtual images sequentially in the workflow as guidance for the user to indicate the alignment points sequentially with reference to the virtual images.

6. The one or more non-transitory computer-readable media of claim 1, wherein:
the sensing of the alignment points comprises sensing the user indicating the alignment points sequentially;
the registering of the alignment points includes registering each of the alignment points as the alignment point is sensed; and
the acts further comprise presenting to the user, in accordance with an alignment point being registered, an indication that the alignment point has been sensed.

7. The one or more non-transitory computer-readable media of claim 1, wherein the correlating of the registered alignment points with the corresponding reference points of the model comprises:
photo-matching the reference positions with the registered alignment points to previously captured photos of corresponding portions of the real world asset.

8. The one or more non-transitory computer-readable media of claim 1, wherein the acts further comprise:
finding a correlation of a previously determined minimum number of alignment points sufficient to define a three-dimensional real world object for which a virtual representation of that real world object may be a proxy for the real world object to carry out the task in accordance with the workflow.

9. An extended reality-enabled user device, comprising:
one or more processors; and
memory containing computer-executable code that upon execution by the one or more processors cause the one or more processors to perform acts comprising:
obtaining a template related to a real world asset present in an extended reality (XR) environment;
launching a workflow providing instructions to carry out a task with respect to the real world asset in the XR environment in accordance with information contained in the template;
sensing an indication of alignment points with respect to the real world asset;
registering the indicated points as alignment points to be correlated with a representation of the real world asset;
correlating the registered alignment points with corresponding reference points of a model of the real world asset; and
locking the real world asset as perceived by a user interacting with the real world asset via the XR-enabled user device in the XR environment, to the model of the real world asset according to the correlated alignment points.

10. The extended reality-enabled user device of claim 9, wherein the acts further comprise:
accessing physical and virtual content related to the real world asset from the template,
wherein the instructions guide the user with the virtual content to interact with physical aspects of the real world asset embodied in the physical content to carry out the task.

11. The extended reality-enabled user device of claim 10, wherein the physical content includes physical representations of the real world asset and the virtual content includes a sequence of the instructions customized to the physical representations of the real world asset.

12. The extended reality-enabled user device of claim 9, wherein the acts further comprise:
displaying the instructions to the user via the XR-enabled user device configured to present the XR environment to the user, the instructions being presented at least in part as virtual content in the user's view via the XR-enabled user device.

13. The extended reality-enabled user device of claim 9, wherein:
the instructions include virtual images, presented via the user device, of reference positions on the real world asset, each of the reference positions including a respective one of the alignment points; and
the instructions present the virtual images sequentially in the workflow as guidance for the user to indicate the alignment points sequentially with reference to the virtual images.

14. The extended reality-enabled user device of claim 9, wherein:
the sensing of the alignment points comprises sensing the user indicating the alignment points sequentially;
the registering of the alignment points includes registering each of the alignment points as the alignment point is sensed; and
the acts further comprise presenting to the user, in accordance with an alignment point being registered, an indication that the alignment point has been sensed.

15. The extended reality-enabled user device of claim 9, wherein the correlating of the registered alignment points with the corresponding reference points of the model comprises:
photo-matching the reference positions with the registered alignment points to previously captured photos of corresponding portions of the real world asset.

16. The extended reality-enabled user device of claim 9, wherein the acts further comprise:
finding a correlation of a previously determined minimum number of alignment points sufficient to define a three-dimensional real world object for which a virtual representation of that real world object may be a proxy for the real world object to carry out the task in accordance with the workflow.

17. A method of multipoint touch alignment for a real world object in extended reality (XR), comprising:
obtaining a template related to a real world asset present in an XR environment;
launching a workflow providing instructions to carry out a task with respect to the real world asset in the XR environment in accordance with information contained in the template;
sensing an indication of alignment points with respect to the real world asset;
registering the indicated points as alignment points to be correlated with a representation of the real world asset;
correlating the registered alignment points with corresponding reference points of a model of the real world asset; and
locking the real world asset as perceived by a user interacting with the real world asset via an XR-enabled user device in the XR environment, to the model of the real world asset according to the correlated alignment points.

18. The method of claim 17, further comprising:
accessing physical and virtual content related to the real world asset from the template,
wherein the instructions guide the user with the virtual content to interact with physical aspects of the real world asset embodied in the physical content to carry out the task.

19. The method of claim 18, wherein the physical content includes physical representations of the real world asset and the virtual content includes a sequence of the instructions customized to the physical representations of the real world asset, and wherein the method further comprises:
displaying the instructions to the user via the XR-enabled user device, the instructions being presented at least in part as virtual content in the user's view via the XR-enabled user device, wherein:
the instructions include virtual images, presented via the XR-enabled user device, of reference positions on the real world asset, each of the reference positions including a respective one of the alignment points; and
the instructions present the virtual images sequentially in the workflow as guidance for the user to indicate the alignment points sequentially with reference to the virtual images.

20. The method of claim 17, wherein:
the sensing of the alignment points comprises sensing the user indicating the alignment points sequentially;
the registering of the alignment points includes registering each of the alignment points as the alignment point is sensed;
the correlating of the registered alignment points with the corresponding reference points of the model comprises:
photo-matching the reference positions with the registered alignment points to previously captured photos of corresponding portions of the real world asset; and
the acts further comprise:
finding a correlation of a previously determined minimum number of alignment points sufficient to define a three-dimensional real world object for which a virtual representation of that real world object may be a proxy for the real world object to carry out the task in accordance with the workflow.
